(19) United States
(12) Patent Application Publication
(10) Pub. No.: US 2018/0065436 A1
(43) Pub. Date: Mar. 8, 2018

(54) SUSPENSION ARM AND MANUFACTURING METHOD THEREOF

(71) Applicant: TOYOTA JIDOSHA KABUSHIKI KAISHA, Toyota-shi (JP)

(72) Inventor: Hajime TSUNEKAWA, Aisai-shi (JP)

(73) Assignee: TOYOTA JIDOSHA KABUSHIKI KAISHA, Toyota-shi (JP)

(21) Appl. No.: 15/641,630

(22) Filed: Jul. 5, 2017

(30) Foreign Application Priority Data
Sep. 5, 2016 (JP) 2016-172789

(51) Int. Cl. B60G 7/00; B29C 70/68

(52) U.S. Cl. CPC B60G 7/001; B29C 70/46; B29C 70/68

(57) ABSTRACT

A suspension arm includes: a vibration-proof bush including tubular fittings, a tubular elastic member formed on an outer periphery of the tubular fittings, and a resin band that is wound around an outer peripheral surface of the tubular elastic member and imparts a pre-compression in a radial direction of the tubular elastic member; and a resin arm fixed to the vibration-proof bush by integrally forming a resin material so as to surround the outer periphery of the vibration-proof bush.

### CROSS REFERENCE TO RELATED APPLICATIONS

This application is based upon and claims the benefit of priority from Japanese patent application No. 2016-172789, filed on Sep. 5, 2016, the disclosure of which is incorporated herein in its entirety by reference.

### BACKGROUND

The present disclosure relates to a suspension arm to be mounted on a vehicle or the like, and a manufacturing method thereof.

A suspension arm including a resin bracket, a vibration-proof bush press-fitted into a mounting hole of the resin bracket, and an arm formed integrally with the resin bracket is known (see Japanese Unexamined Patent Application Publication No. H11-028920).

In the above-mentioned suspension arm, the vibration-proof bush is directly press-fitted into the mounting hole of the resin bracket without using, for example, an external cylinder. Accordingly, there is a possibility that a sufficient pre-compression may not be imparted to the vibration-proof bush.

### SUMMARY

The present disclosure has been made to solve the above-mentioned problem, and a primary object of the present disclosure is to provide a suspension arm capable of incorporating, into a resin arm, a vibration-proof bush to which a sufficient pre-compression is imparted, and a manufacturing method thereof.

In order to attain the above-mentioned object, one aspect of the present disclosure is a suspension arm including: a vibration-proof bush including tubular fittings, a tubular elastic member formed on an outer periphery of the tubular fittings, and a resin band that is wound around an outer peripheral surface of the tubular elastic member and imparts a pre-compression in a radial direction of the tubular elastic member; and a resin arm fixed to the vibration-proof bush by integrally forming a resin material so as to surround an outer periphery of the vibration-proof bush.

According to this aspect, the resin band of the vibration-proof bush is wound around the outer peripheral surface of the tubular elastic member, thereby making it possible to impart a sufficient pre-compression to the tubular elastic member. Further, the resin arm is formed integrally with the vibration-proof bush, thereby making it possible to impart, into the resin arm, the vibration-proof bush to which a sufficient pre-compression is imparted.

In this aspect, the resin band and the resin arm may be made of resin materials of the same type. As a result, the integrity of the resin arm with the resin band wound around the tubular elastic member can be increased.

In order to attain the above-mentioned object, another aspect of the present disclosure may be a manufacturing method of a suspension arm, including: forming a tubular elastic member on an outer periphery of tubular fittings; generating a vibration-proof bush by winding a resin band around an outer peripheral surface of the formed tubular elastic member and imparting a pre-compression in a radial direction of the tubular elastic member; and integrally forming a resin arm so as to surround the outer periphery of the vibration-proof bush.

According to the present disclosure, it is possible to provide a suspension arm capable of incorporating, into a resin arm, a vibration-proof bush to which a sufficient pre-compression is imparted, and a manufacturing method thereof.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is a perspective view illustrating a schematic structure of a suspension arm according to one embodiment of the present disclosure;

FIG. 2 is a diagram illustrating an example in which a tubular rubber member is formed on an outer periphery of tubular fittings;

FIG. 3 is a diagram illustrating an example of a state where a resin band is wound around an outer peripheral surface of the tubular rubber member; and

FIG. 4 is a flowchart illustrating a flow of a manufacturing method of the suspension arm according to one embodiment of the present disclosure.

### DESCRIPTION OF EMBODIMENTS

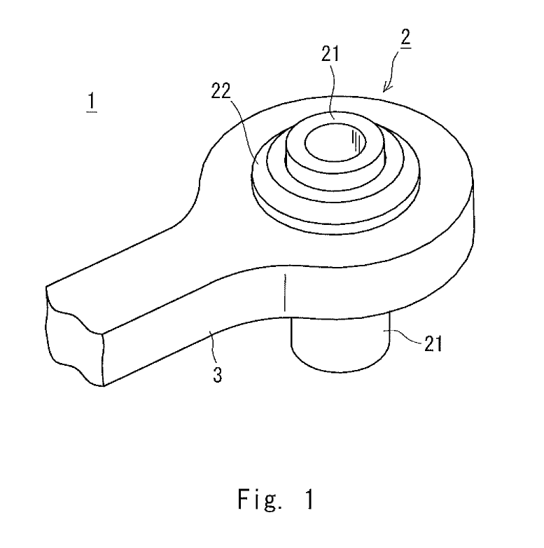

Embodiments of the present disclosure will be described below with reference to the drawings. FIG. 1 is a perspective view illustrating a schematic structure of a suspension arm according to one embodiment of the present disclosure. A suspension arm 1 according to this embodiment is incorporated into, for example, a suspension mechanism of a vehicle. The suspension arm 1 according to this embodiment includes a vibration-proof bush 2 that absorbs vibrations, and a resin arm 3 to which the vibration-proof bush 2 is fixed.

The vibration-proof bush 2 includes tubular fittings 21, a tubular rubber member 22 that is coaxially disposed at the outer periphery of the tubular fittings 21, and a resin band 23 that is wound around the outer peripheral surface of the tubular rubber member 22.

The tubular fittings 21 are made of, for example, metal such as an aluminum alloy or iron, and are formed into a tubular shape.

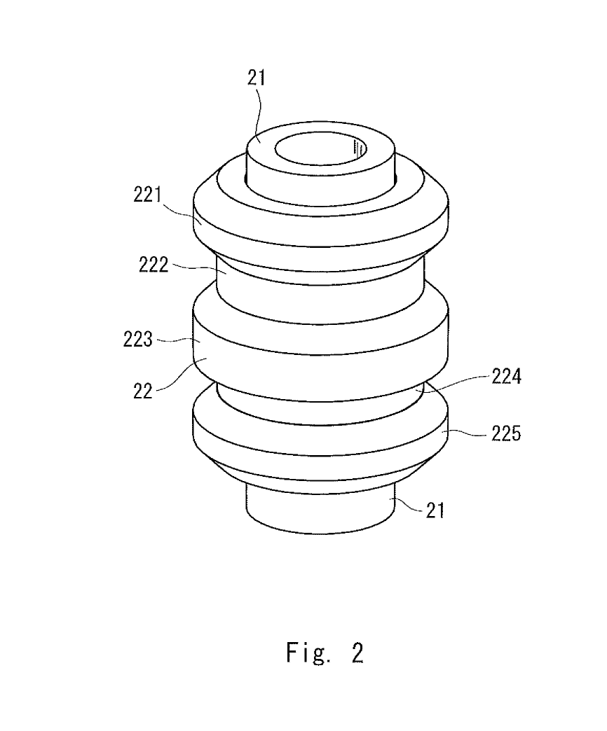

The tubular rubber member 22 is, for example, rubber which is formed into a tubular shape and is integrally formed at the outer periphery of the tubular fittings 21 (FIG. 2). Thus, the tubular rubber member 22 and the tubular fittings 21 are integrally formed, thereby making it possible to reduce man-hours for assembling the tubular rubber member 22 at the outer periphery of the tubular fittings 21. Further, the elastic limit of the tubular rubber member 22 may be increased by vulcanization-molding the tubular rubber member 22. The outer peripheral surface of the tubular fittings 21 and the inner peripheral surface of the tubular rubber member 22 are, for example, vulcanized.

As the material of the tubular rubber member 22, natural rubber, which is generally used for vibration-proof rubber, or synthetic rubber, such as SBR (styrene-butadiene rubber), BR (butadiene rubber), IR (isoprene rubber), NBR (acrylonitrile-butadiene rubber), CR (chloroprene rubber), IIR (butyl rubber), EPDM (ethylene-propylene rubber), or PUR (polyurethane), is used. Compounding ingredients such as a vulcanizing agent, vulcanizing accelerator, antioxidant, reinforcing agent, filler, or softener are mixed in the raw rubber, to thereby obtain a predetermined elastic modulus, mechanical strength, dynamic characteristics, fatigue characteristics, and the like.

Note that the tubular rubber member 22 is a specific example of a tubular elastic member. The tubular elastic member is not limited to the tubular rubber member 22 made of the above-mentioned rubber. For example, an elastomeric resin, such as urethane, may also be used.

The tubular rubber member 22 is provided with, for example, a first convex part 221, a first concave part 222, a second convex part 223, a second concave part 224, and a third convex part 225. The first convex part 221 is formed at an upper end of the tubular rubber member so as to be convex along the circumferential direction. The first concave part 222 is adjacent to the lower side of the first convex part 221 and is formed in a concave shape along the circumferential direction. The second convex part 223 is adjacent to the lower side of the first concave part 222 and is formed in a convex shape along the circumferential direction. The second concave part 224 is adjacent to the lower side of the second convex part 223 and is formed in a concave shape along the circumferential direction. The third convex part 225 is adjacent to the lower side of the second concave part 224 and is formed in a convex shape along the circumferential direction. Note that the structure of the tubular rubber member 22 is merely an example and is not limited to this structure.

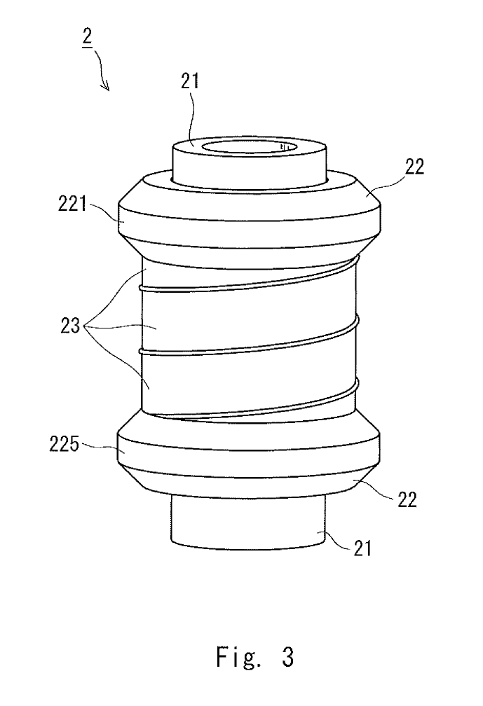

The resin band 23 is wound around the outer peripheral surface of the tubular rubber member 22, and the tubular rubber member 22 is tightened in the radial direction thereof, thereby imparting a pre-compression in the radial direction of the tubular rubber member 22 (FIG. 3). Thus, as pre-compression is imparted to the tubular rubber member 22, the durability of the tubular rubber member 22 is improved. The resin band 23 is, for example, a band-like synthetic resin. The resin band 23 is, for example, substantially uniformly wound around the first concave part 222, the second convex part 223, and the second concave part 224, which are disposed between the first convex part 221 and the third convex part 225 of the tubular rubber member 22, in a spiral shape. Thus, a sufficient pre-compression can be imparted in the radial direction between the first convex part 221 and the third convex part 225 of the tubular rubber member 22.

Note that the method of winding the resin band 23 is illustrated by way of example only and is not limited to the above method. Any winding method can be applied as long as the resin band 23 can impart a sufficient pre-compression to the tubular rubber member 22.

A winding force for the resin band 23 to be wound around the outer peripheral surface of the tubular rubber member 22 is appropriately adjusted so that, for example, an optimum pre-compression is imparted to the tubular rubber member 22. This method capable of easily adjusting the winding force of the resin band 23 makes it possible to impart an optimum pre-compression to the tubular rubber member 22 more easily and accurately than in the method in which an external cylinder is provided on the outer peripheral surface of the tubular rubber member 22 of the related art.

The resin arm 3 is fixed to the vibration-proof bush 2 by integrally forming a resin material so as to surround the outer periphery of the vibration-proof bush 2. The resin arm 3 is, for example, a fiber-reinforced resin including carbon fiber and the like. Thus, when the resin arm 3 is formed using a fiber-reinforced resin or the like, in addition to the durability and high rigidity of the resin arm 3, a reduction in the weight of the resin arm 3 can be ensured at the same time. Further, the resin arm 3 is formed integrally with the vibration-proof bush 2, thereby reducing assembly man-hours for assembling the vibration-proof brush 2 to the resin arm 3.

For example, the vibration-proof bush 2 is disposed in a resin mold of the resin arm 3, and the resin arm 3 and the vibration-proof bush 2 are integrally formed by injection molding, SMC (Sheet Molding Compound) molding, or the like.

The resin band 23 and the resin arm 3 are preferably made of the same type of resin material. This makes it possible to increase the integrity between the resin arm 3 and the resin band 23 wound around the tubular rubber member 22. Any resin material may be used as the resin material for the resin band 23, as long as the resin material has an excellent adhesion compatibility with the resin arm 3 and excellent thermal expansion.

In recent years, there has been a demand for a further reduction in weight of a suspension arm for the purpose of reducing the weight of a vehicle. On the other hand, an attempt to replace the arm itself of the suspension arm with a light-weight material such as resin has been made. A vibration-proof bush is generally incorporated into the resin arm. In this case, for example, a sleeve is formed integrally with the resin arm and the vibration-proof bush is press-fit into the sleeve. In this method, however, the provision of the sleeve leads to an increase in the number of components, cost, and mass. Further, the provision of the sleeve press-fitting step leads to an increase in assembly man-hours.

A sufficient pre-compression cannot be imparted to the vibration-proof bush only by press-fitting the vibration-proof bush into the mounting hole of the resin arm, which leads to deterioration in the durability of the vibration-proof bush. On the other hand, a metallic external cylinder may be provided at the outer periphery of the tubular rubber member of the vibration-proof bush, and the metallic external cylinder may be squeezed inward, thereby making it possible to provide the tubular rubber member with a sufficient pre-compression. However, if the vibration-proof bush is directly press-fit into the mounting hole of the resin arm without providing the sleeve on the resin arm, the metallic external cylinder of the vibration-proof bush comes into contact with the mounting hole of the resin arm, which may cause a problem that the base material of the resin arm is scraped by the external cylinder. Further, the metallic external cylinder may cause problems such as an increase in mass and electric corrosion. On the other hand, when the resin external cylinder is provided at the outer periphery of the tubular rubber member, abrasion of the base material of the resin arm during press-fitting is alleviated. However, in this case, the vibration-proof bush cannot be press-fitted into the mounting hole of the resin arm in a state where the resin external cylinder is squeezed inward and a sufficient pre-compression is imparted to the tubular rubber member.

On the other hand, as described above, the suspension arm 1 according to this embodiment includes: the vibration-proof bush 2 including the resin band 23 that is wound around the outer peripheral surface of the tubular rubber member 22 and imparts a pre-compression in the radial direction of the tubular rubber member 22; and the resin arm 3 that is fixed to the vibration-proof bush 2 by integrally forming a resin material so as to surround the outer periphery of the vibration-proof bush 2.

With this structure, the resin band 23 of the vibration-proof bush 2 is wound around the outer peripheral surface of the tubular rubber member 22, thereby making it possible to impart a sufficient pre-compression to the tubular rubber member 22. Further, the resin arm 3 is formed integrally with the vibration-proof bush 2, thereby allowing the vibration-proof bush 2 in a state where a sufficient pre-compression is imparted to the rubber member to be incorporated in the resin arm 3. Note that when the resin arm 3 is formed integrally with the vibration-proof bush 2, the press-fit step of press-fitting the vibration-proof bush 2 into the resin arm 3 can be eliminated. This leads to prevention of abrasion of the base material of the resin arm 3 and simplification of the assembly steps. Furthermore, the use of the resin band 23 which has a light weight and insulating properties makes it possible to avoid the electric corrosion and suppression of a mass.

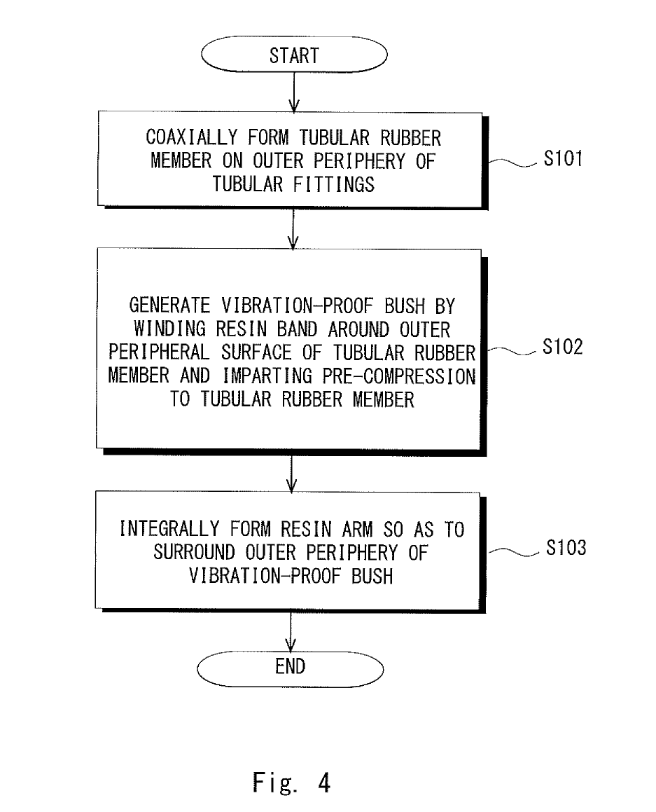

FIG. 4 is a flowchart showing a flow of a manufacturing method of the suspension arm according to this embodiment.

The tubular rubber member 22 is coaxially vulcanization-molded integrally with the outer periphery of the tubular fittings 21 (FIG. 2) (step S101).

The resin band 23 is wound around the outer peripheral surface of the vulcanization-molded tubular rubber member 22, thereby generating the vibration-proof bush 2 in which a pre-compression is imparted in the radial direction of the tubular rubber member 22 (FIG. 3) (step S102).

The vibration-proof bush 2 is disposed in a mold and the resin arm 3 is integrally formed so as to surround the outer periphery of the vibration-proof bush 2 (FIG. 1) (step S103).

The suspension arm 1 according to this embodiment having the structure as described above is connected in a vibration-proof manner by, for example, an attachment axial part of another connecting arm, an attachment member, or the like being fitted and fixed into the cylinder of the tubular fittings 21 of the vibration-proof brush 2 by bolt fastening or the like, and incorporated into the suspension mechanism of the vehicle. Thus, the vibration generated between the suspension arm 1 and the connecting arm or the like connected to the suspension arm 1 can be effectively absorbed by an elastic action of the tubular rubber member 22 of the vibration-proof bush 2.

As described above, the suspension according to this embodiment includes: the vibration-proof bush 2 including the tubular fittings 21, the tubular rubber member 22 formed at the outer periphery of the tubular fittings 21, and the resin band 23 that is wound around the outer peripheral surface of the tubular rubber member 22 and imparts a pre-compression in the radial direction of the tubular rubber member 22; and the resin arm 3 that is fixed to the vibration-proof bush 2 by integrally forming a resin material so as to surround the outer periphery of the vibration-proof bush 2.

With this structure, the resin band 23 of the vibration-proof bush 2 is wound around the outer peripheral surface of the tubular rubber member 22, thereby making it possible to impart a sufficient pre-compression to the tubular rubber member 22. Further, since the resin arm 3 is formed integrally with the vibration-proof bush 2, the vibration-proof bush 2 in a state where a sufficient pre-compression is imparted to the tubular rubber member can be incorporated into the resin arm 3.

Note that the present disclosure is not limited to the above embodiments and can be modified as appropriate without departing from the gist of the invention.

From the invention thus described, it will be obvious that the embodiments of the invention may be varied in many ways. Such variations are not to be regarded as a departure from the spirit and scope of the invention, and all such modifications as would be obvious to one skilled in the art are intended for inclusion within the scope of the following claims.

What is claimed is:

1. A suspension arm comprising:
a vibration-proof bush including tubular fittings, a tubular elastic member formed on an outer periphery of the tubular fittings, and a resin band that is wound around an outer peripheral surface of the tubular elastic member and imparts a pre-compression in a radial direction of the tubular elastic member; and
a resin arm fixed to the vibration-proof bush by integrally forming a resin material so as to surround an outer periphery of the vibration-proof bush.

2. The suspension arm according to claim 1, wherein the resin band and the resin arm are made of resin materials of the same type.

3. A manufacturing method of a suspension arm, comprising:
forming a tubular elastic member on an outer periphery of tubular fittings;
generating a vibration-proof bush by winding a resin band around an outer peripheral surface of the formed tubular elastic member and imparting a pre-compression in a radial direction of the tubular elastic member; and
integrally forming a resin arm so as to surround the outer periphery of the vibration-proof bush.
